(19) United States
(12) Patent Application Publication
(10) Pub. No.: US 2025/0029975 A1
(43) Pub. Date: Jan. 23, 2025

(54) METHOD FOR SOLVENT-FREE PRODUCTION OF AN ELECTRODE AND PROVIDED ELECTRODE

(71) Applicants: FRAUNHOFER-GESELLSCHAFT ZUR FÖRDERUNG DER ANGEWANDTEN FORSCHUNG E.V., München (DE); TECHNISCHE UNIVERSITÄT DRESDEN, Dresden (DE)

(72) Inventors: Florian SCHMIDT, Dresden (DE); Susanne DÖRFLER, Dresden (DE); Holger ALTHUES, Dresden (DE); Stefan KASKEL, Dresden (DE); Benjamin SCHUMM, Dresden (DE); Sebastian TSCHÖKE, Dresden (DE)

(73) Assignees: FRAUNHOFER-GESELLSCHAFT ZUR FÖRDERUNG DER ANGEWANDTEN FORSCHUNG E.V., München (DE); TECHNISCHE UNIVERSITÄT DRESDEN, Dresden (DE)

(21) Appl. No.: 18/684,073

(22) PCT Filed: Aug. 17, 2022
(86) PCT No.: PCT/EP2022/072998

§ 371 Date: Feb. 15, 2024

(30) Foreign Application Priority Data
Aug. 19, 2021 (DE) 10 2021 209 121.0

(51) Int. Cl. H01M 4/04; H01M 4/02; H01M 4/62; H01M 10/0525

(52) U.S. Cl. CPC H01M 4/0435; H01M 4/622; H01M 2004/021; H01M 10/0525

(57) ABSTRACT

The invention relates to a method for solvent-free production of an electrode. By means of the method it is possible to produce an electrode which has high mechanical stability and which provides a high specific capacitance. The method also enables the production of an electrode which can be used as an anode in a lithium-ion battery, without giving rise to unstable operation with undesirable and irreversible degradation reactions. An electrode is also provided, which has the above-mentioned advantages. In addition, uses of the electrode according to the invention are proposed.

A method for solvent-free production of an electrode is provided. As a result of the method, an electrode is producible that has a high mechanical stability and that provides a high specific capacity. The method additionally allows for the production of an electrode that may be used as an anode in a lithium-ion battery, without resulting in unstable operation with undesired and irreversible degradation reactions. In addition, an electrode is provided which has the above-stated advantages. In addition, uses of the electrode according to the invention are proposed.

In the production of battery electrodes, layers 50-100 μm thick have to be applied with high trajectory speeds to metal current collectors. This occurs routinely by means of wet-chemical roll-to-roll application from suspensions of active materials in aqueous or organic solvents. In the prior art, CMC/SBR or PVDF are often used as anode binders in such wet-chemical, i.e. solvent-based, methods. A multitude of alternatives are also found in scientific publications, including also polyamides, such as the polypeptide sericin. Wet-chemical methods, however, have the disadvantage that, for the production of an electrode (for example an anode), a high energy input is necessary both the for dispersing of the material (for example active material) and for the drying of the produced battery electrode layer.

Producing electrode layers solvent-free, that is to say by means of a dry production method, constitutes an energy advantage. To this end, dry powder mixturees formed from active material, conductive additives and suitable binders must be converted into mechanically loadable layers. In these methods in the prior art, polytetrafluoroethylene (PTFE) is usually used as binder, it being known that this forms fibrils under the action of shear forces (see for example WO 2018/210723 A1). The disadvantage of PTFE as binder for electrode materials in dry-chemical methods, however, is that PTFE in the case of lithium-ion batteries may only be used for the binders of cathodes. The reason for this is that PTFE as binder in anodes with an anode potential close to 0V (Li/Li+) is electrochemically unstable and during operation brings about undesirable and irreversible degradation reactions.

As an alternative to the use of PTFE in dry-chemical methods for the production of an electrode layer, it is known to use PVDF and polyolefins (see for example U.S. Pat. No. 7,883,553 B2). The disadvantage of the use of these binders, however, is that the binder fraction must be high in order to ensure a sufficient mechanical stability of the produced electrode layer, which is at the expense of the achievable capacity of the electrode. In addition, the processability in the case of these binders is much more difficult.

For the production of an electrode by means of the dry process, which is advantageous from an energy perspective, the prior art has not previously disclosed a binder for anodes that on the one hand may ensure a high mechanical stability of the produced anode and on the other hand may be used in low proportions in order to allow high capacities of the produced anode.

Proceeding from this basis, the object of the present invention was to provide a method for solvent-free production of an electrode and additionally to provide an electrode which overcomes the disadvantages known in the prior art. In particular, it should be possible with the method to provide an electrode that has a high mechanical stability, may provide a high specific capacity and, when used as an anode in lithium-ion batteries, allows a stable operation without undesired or irreversible degradation reactions.

The object is achieved by the method with the features of claim 1, the electrode with the features of claim 12, and the use with the features of claim 15. The dependent claims present advantageous embodiments.

A method for the solvent-free production of an electrode is provided in accordance with the invention, said method comprising or consisting of the following steps:
a) providing a dry powder mixture for production of an electrode, said mixture comprising or consisting of:
   at least one active material for an electrode,
   at least one electrically conductive additive, and
   at least one binder; and
b) exerting a mechanical force on the powder mixture, wherein a dry film is formed form the dry powder mixture;
   characterized in that
   the at least one binder comprises or consists of a polyamide which is suitable for forming fibrils under the action of a mechanical force.

The term “dry powder mixture” means a powder mixture that is free from solvents (for example free from water). The term “polyamide” is also understood to mean molecules that have a repeating peptide bond (—CO—NH bond), i.e. this term is also understood to include polypeptides or proteins.

The at least one binder of the dry powder mixture provided in step a) may be present already partly fibrillated. For example, the dry powder mixture may be mechanically sheared during its provision so that, in part, fibrils are created from the at least one binder. This powder mixture may then be used (optionally after a renewed comminution) in step b) for the formation of the dry film, wherein, on account of the mechanical force acting here, further fibrils are created from the binder.

The mechanical force exerted in the method on the dry powder mixture comprises, in particular, a pressing force and a shearing force, or consists thereof.

It has been found that, in this dry-chemical method, even very small proportions of the binder in the dry powder mixture lead to an electrode that is distinguished by a high mechanical stability. Due to the option to use small binder proportions, the produced battery electrode layer may have a high specific capacity. In addition, the electrode produced by means of this dry-chemical method with the polyamide-based binder has the advantage, compared to an electrode produced with a PTFE-based binder, that it allows stable operation without undesired and irreversible degradation reactions when used as an anode in a lithium-ion battery.

The method according to the invention may be characterized in that the polyamide comprises or consists of a polypeptide, wherein the polypeptide is preferably a polypeptide that is suitable for forming a β-sheet secondary structure under the action of mechanical force. It is suspected that the suitability of the polypeptide to form fibrils under the action of mechanical force is based on its suitability for forming a β-sheet secondary structure under the action of mechanical force. The polypeptide is particularly preferably a silk polypeptide (in particular silk protein), wherein the silk polypeptide (in particular silk protein) is very particularly preferably selected from the group consisting of sericin, fibroin, spider silk polypeptide (in particular spider silk protein) and combinations hereof. In particular, the silk polypeptide (or silk protein) is sericin, preferably unhydrolyzed sericin. The advantage of unhydrolyzed sericin is that the molecular chain length of the polypeptide (i.e. its molecular weight) is greater than in the case of hydrolyzed sericin, whereby fibril formation is possible in the first place or, in the method according to the invention, longer fibrils are produced, which increases the mechanical stability of the produced electrode.

Due to the action of the mechanical force on the powder mixture in step b), the at least one binder of the dry powder mixture forms fibrils, preferably at least in part. The formed fibrils increase the mechanical stability of the produced electrode layer.

The at least one binder of the dry powder mixture may be present in the dry powder mixture in a concentration of from 0.1 wt. % to 10 wt. %, preferably 1 wt. % to 5 wt. % in relation to the total weight of the powder mixture. The lower the concentration (or the proportion) of the binder in the dry powder mixture is, the higher is the specific capacity of the electrode provided by means of the method, since the relative proportion of active material is correspondingly higher.

The at least one active material of the dry powder mixture may be an active material for an anode, preferably an active material selected from the group consisting of carbon, silicon, combinations hereof and composite materials hereof. The carbon is in particular selected from the group consisting of graphite, non-graphitizable carbon, and combinations hereof.

Alternatively, the at least one active material of the dry powder mixture may be an active material for a cathode, preferably an active material selected from the group consisting of LiCoO₂, LiNiO₂, LiFePO₄, LiMnO₂, LiMn₂O₄, Li₂Mn₃NiO₈, Li₄Ti₅O₁₂, Li₂FeSiO₄, Na₂S, Na₃V₂(PO₄)₃, NaFePO₄, Na₂FePO₄F, NaNiMnO₂, Na₂TiO₇, NaTi₂(PO₄)₃, LiNi₁₋ₓCoₓO₂ (wherein x lies in the range of from 0 to 1), LiNiₓCo_{y}Mn_{z}O₂ (wherein x+y+z=1), LiNiₓCo_{y}Al_{z}O₂ (wherein x+y+z=1), NaₓMnO₂ (wherein x is between 0.5 and 1), and combinations hereof.

The at least one active material of the dry powder mixture may be present in the dry powder mixture in a concentration of from 60 wt. % to 99 wt. %, preferably 76 wt. % to 97 wt. %, particularly preferably 86 wt. % to 96 wt. %, very particularly preferably 91 wt. % to 95 wt. %, in particular 92 wt. % to 94 wt. %, in relation to the total weight of the powder mixture. The higher the concentration (or the proportion) of active material in the dry powder mixture is, the higher is the achievable specific capacity of the electrode provided by means of the method.

The at least one electrically conductive additive of the dry powder mixture can be present in the dry powder mixture in a concentration of from 1 wt. % to 35 wt. %, preferably 1 wt. % to 20 wt. %, particularly preferably 1.5 wt. % to 10 wt. %, very particularly preferably 2 wt. % to 5 wt. %, in particular 2 wt. % to 4 wt. %, in relation to the total weight of the powder mixture. The lower the concentration (or the proportion) of electrically conductive additive in the dry powder mixture is, the higher may be the proportion of active material, which increases the achievable specific capacity of the electrode producible by means of the method. The concentration range from 2 to 4 wt. % in this case represents an optimum of electrical conductivity on the one hand and achievable capacity on the other hand.

The at least one electrically conductive additive of the dry powder mixture may comprise or consist of a carbon, wherein the carbon is preferably selected from the group consisting of carbon black, carbon nanotubes, carbon nanofibers, carbon fibers, graphene and combinations hereof.

The dry powder mixture is preferably free from at least one material selected from the group consisting of PTFE, PVDF, carboxymethylcellulose, styrene-butadiene rubber and polyolefin, particularly preferably is free from all of these materials.

A preferred embodiment of the method is characterized in that step b) of the method comprises or consists of an application of the dry powder mixture in a calender nip, wherein the calender nip is formed by a first rotating roller and a second rotating roller, and wherein the second rotating roller has a faster speed of revolution than the first roller. The dry film is formed here in the calender nip. The resultant dry film is carried along on the first rotating roller. The ratio of the speed of revolution of the second roller to the first roller may lie in the range of from 10:1 to 2:1 (optionally in the range of from 9:1 to 3:1). The rollers may have the same of a different diameter. It is key that the speed of revolution of the two rollers, i.e. the speed of revolution of the respective surface of the two rollers at the calender nip, is different.

The distance from the first rotating roller to the second rotating roller may be set so that the calender nip has a width in the range of from 10 μm to 200 μm, preferably in the range of from 20 μm to 100 μm, particularly preferably in the range of from 40 am to 60 μm.

In a preferred embodiment of the method, step b) comprises arranging the dry film on a flat electrical conductor (for example a metal foil). By way of this arrangement, a laminate of an electrode on a flat electrical conductor is created.

In accordance with the invention, an electrode is also provided, comprising
a) a dry film which comprises or consists of at least one active material for an electrode, at least one electrically conductive additive and at least one binder; and
b) optionally: a flat electrical conductor, on which the dry film is arranged;
   or consisting thereof,
   characterized in that the at least one binder comprises or consists of a polyamide which is present in the dry film at least in part in the form of fibrils.

The electrode according to the invention has a high mechanical stability and is suitable, on account of low binder proportions, for providing a high specific capacity. With use of the electrode as an anode in a lithium-ion battery, this allows a stable operation without undesired and irreversible degradation reactions.

The fibrils in the electrode may have a diameter in the range of from >0 nm to <1 μm, determined via scanning electron microscopy. The advantage of this small diameter is that the fibrils, in relation to their volume, expose a large surface which allows a high binding effect to the active material or the electrically conductive additive and increases the mechanical stability.

In a preferred embodiment, the electrode has been produced by a method according to the invention. The electrode according to the invention may therefore have features that inevitably result on account of the execution of the method according to the invention.

Lastly, the use of the electrode according to the invention in a lithium-ion battery, preferably in an, or as an, anode of a lithium-ion battery is proposed.

The subject matter according to the invention will be explained in greater detail on the basis of the following figures and examples, without wishing to limit it to the specific embodiments presented here.

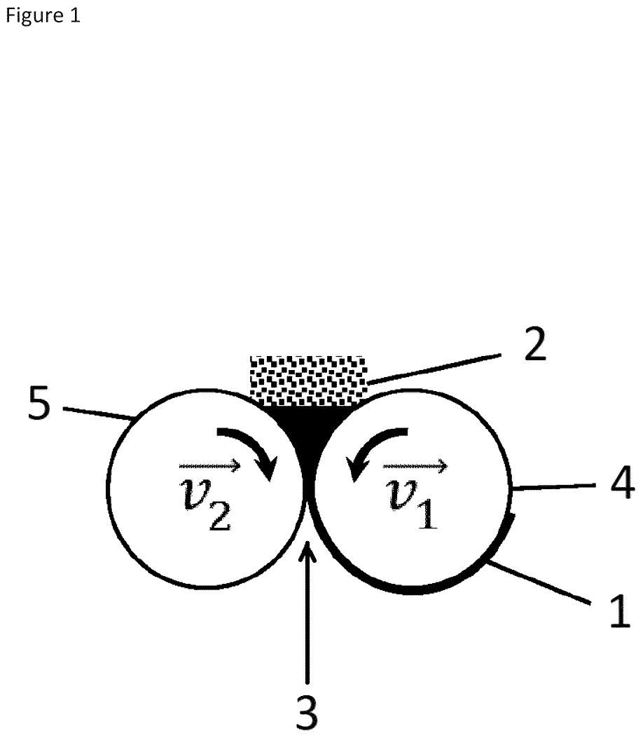

FIG. 1 shows schematically an example of a method according to the invention. To produce the electrode layer (or the dry film) 1, a dry powder mixture 2 is introduced into a calender nip 3 between a first roller 4 and a second roller 5. The first roller rotates and a first speed of revolution υ₁ and the second roller rotates at a second speed of revolution υ₂, wherein the second speed of revolution υ₂ is faster than the first speed of revolution υ₁. Due to the short distance between the two rollers 4, 5 and their different speeds of revolution υ₁, υ₂, a pressing force and a shearing force are exerted on the dry powder mixture, which leads to the formation of the dry film 1 which has the fibrils of the binder. The dry film 1, after passing the calender nip 3, is guided on the first roller 4 and may then be applied to a flat electrical conductor (for example a metal film).

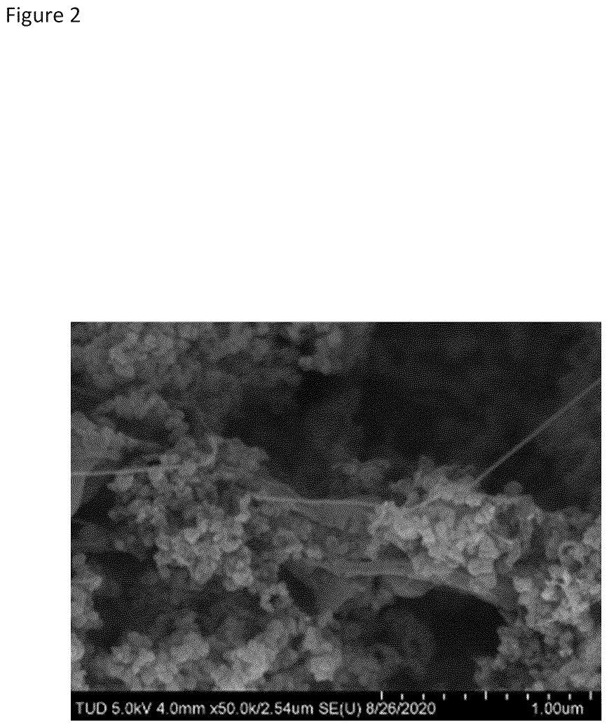

FIG. 2 shows an image taken by means of electron microscopy of an electrode layer produced by means of the method according to the invention. It is visible in the image that the polyamide has formed fibrils with a diameter in the submicrometer range in the binder (here: the polypeptide sericin) on account of the mechanical force action during the method. The formed fibrils increase the mechanical stability of the electrode layer.

### Example 1—Embodiment of a Method According to the Invention

The polypeptide sericin is added to a mixture of active material and electrically conductive additive, whereby a dry mixture is formed. The proportion of sericin in this dry mixture is, in this case, 3 wt. % in relation to the total mass of the composition. The dry mixture is comminuted in an XV mill, thus creating a dry powder mixture 2.

Under the action of a mechanical force on the dry powder mixture 2, a dry film is then formed by introducing the dry powder mixture 2 into a calender nip 3 which is formed by a first roller 4 and a second roller 5. The first roller 4 rotates and a first speed of revolution υ₁ and the second roller 5 rotates at a second speed of revolution υ₂, which is faster than the first speed of revolution υ₁. The ratio of the speed of revolution υ₂:υ₁ was, in this case, 2:1. The dry powder mixture 2 was hereby pressed and oriented to form a dry film 1, wherein the dry film 1 was carried along on the first roller 4. The dry film 1 thus created represents an electrode.

The dry film 1 may then be transferred from the first roller 4 to a flat electrical conductor (for example a metal foil) (not shown in FIG. 1), thus creating a laminate. In this case, a dry film (electrode film) adhering to the flat electrical conductor is obtained.

The use of this laminate in lithium-ion battery cells confirmed that the dry film (electrode film) had not only excellent mechanical stability, but also, on account of the lower binder content, a high specific capacity. The use of the laminate as anode in lithium-ion battery cells has revealed that a stable operation of these battery cells is possible with such an anode and there are no undesired or irreversible degradation reactions during the operation of such batteries.

### Example 2—Evidence of Fibrils in the Electrode According to the Invention

An image of the electrode produced in Example 1 was taken by means of electron microscopy (see FIG. 2).

The image shows that fibrils were formed in the electrode. Only the polypeptide sericin, which was used as binder in the dry powder mixture, is considered as a source for the fibril formation. The formed fibrils are responsible for the high mechanical stability of the electrode layer.

### LIST OF REFERENCE SIGNS

1: electrode layer (or dry film);
2: dry powder mixture;
3: calender nip between first and second rollers;
4: first roller;
5: second roller;
υ₁: speed of revolution of the first roller (υ₁<υ₂);
υ₂: speed of revolution of the second roller (υ₂>υ₁).

1-15. (canceled)

16. A method for the solvent-free production of an electrode, said method comprising the following steps:
a) providing a dry powder mixture for the production of an electrode, said dry powder mixture comprising:
at least one active material for an electrode,
at least one electrically conductive additive, and
at least one binder; and
b) exerting a mechanical force on the dry powder mixture and forming a dry film from the dry powder mixture;
wherein the at least one binder comprises a polyamide which is suitable for forming fibrils under the action of a mechanical force.

17. The method according to claim 16, wherein the polyamide comprises a polypeptide.

18. The method according to claim 17, wherein the polypeptide is a polypeptide which forms a p-sheet secondary structure under the action of mechanical force.

19. The method according to claim 18, wherein the polypeptide is a silk polypeptide.

20. The method according to claim 16, wherein the at least one binder of the dry powder mixture
i) at least in part forms fibrils by the action of the mechanical force on the powder mixture in step b) and/or
ii) is present in the dry powder mixture in a concentration of from 0.1 wt. % to 10 wt. % in relation to the total weight of the powder mixture.

21. The method according to claim 16, wherein the at least one active material of the dry powder mixture is an active material for
i) an anode selected from the group consisting of carbon, silicon, and composite materials thereof, wherein the carbon is selected from the group consisting of graphite, non-graphitizable carbon, and combinations thereof; or
ii) a cathode selected from the group consisting of LiCoO₂, LiNiO₂, LiFePO₄, LiMnO₂, LiMn₂O₄, Li₂Mn₃NiO₈, Li₄Ti₅O₁₂, Li₂FeSiO₄, Na₂S, Na₃V₂(PO₄)₃, NaFePO₄, Na₂FePO₄F, NaNiMnO₂, Na₂TiO₇, NaTi₂(PO₄)₃, LiNi₁₋ₓCoₓO₂ wherein x lies in a range of from 0 to 1, LiNiₓCo_{y}Mn_{z}O₂ wherein x+y+z=1, LiNiₓCo_{y}Al_{z}O₂ wherein x+y+z=1, NaₓMnO₂ wherein x is between 0.5 and 1, and combinations thereof.

22. The method according to claim 16, wherein the at least one active material of the dry powder mixture is present in the dry powder mixture in a concentration of from 60 wt. % to 99 wt. % in relation to the total weight of the powder mixture.

23. The method according to claim 16, wherein the at least one electrically conductive additive of the dry powder mixture is present in the dry powder mixture in a concentration of from 1 wt. % to 35 wt. % in relation to the total weight of the powder mixture.

24. The method according to claim 16, wherein the at least one electrically conductive additive of the dry powder mixture comprises a carbon selected from the group consisting of carbon black, carbon nanotubes, carbon nanofibers, carbon fibers, and graphene.

25. The method according to claim 16, wherein the dry powder mixture is free from at least one material selected from the group consisting of PTFE, PVDF, carboxymethylcellulose, styrene-butadiene rubber, and polyolefin.

26. The method according to claim 16, wherein step b) comprises application of the dry powder mixture in a calender nip, wherein the calender nip is formed by a first rotating roller and a second rotating roller, wherein the second rotating roller has a faster speed of revolution than the first roller, wherein the dry film is formed in the calender nip and is carried along on the first rotating roller.

27. The method according to claim 26, wherein a distance from the first rotating roller to the second rotating roller is set so that the calender nip has a width in the range of from 10 μm to 200 μm.

28. The method according to claim 16, wherein step b) comprises arranging the dry film on a flat electrical conductor.

29. An electrode comprising:
a) a dry film which comprises at least one active material for an electrode, at least one electrically conductive additive, and at least one binder; and
b) optionally, a flat electrical conductor on which the dry film is arranged;
wherein the at least one binder comprises a polyamide which is present in the dry film at least in part in the form of fibrils.

30. The electrode according to claim 29, wherein the fibrils have a diameter in the range of from >0 nm to <1 μm, as determined by scanning electron microscopy.

31. An electrode produced by the method of claim 16.

32. A lithium-ion battery comprising the electrode according to claim 29.
